(19) United States
(12) Patent Application Publication
(10) Pub. No.: US 2022/0219479 A1
(43) Pub. Date: Jul. 14, 2022

(54) SECURITY INKS AND MACHINE READABLE SECURITY FEATURES

(71) Applicant: SICPA HOLDING SA, Prilly (CH)

(72) Inventors: Marlyse DEMARTIN MAEDER, La Sarraz (CH); Claude-Alain DESPLAND, Prilly (CH); Patrick VEYA, Aclens (CH)

(21) Appl. No.: 17/614,961

(22) PCT Filed: May 26, 2020
(86) PCT No.: PCT/EP2020/064530

§ 371 Date: Nov. 29, 2021

(30) Foreign Application Priority Data
May 28, 2019 (EP) 19177006.4

(51) Int. Cl. B42D 25/21; B42D 25/382; B42D 25/387; B42D 25/364; C09D 11/033; C09D 11/037; C09D 11/101; C08K 3/34; C08K 3/22; C08K 3/11

(52) U.S. Cl. CPC B42D 25/21; B42D 25/382; B42D 25/387; B42D 25/364; C09D 11/033; C08K 2003/328; C09D 11/101; C08K 3/34; C08K 3/2279; C08K 3/22; C08K 3/11; C09D 11/037

(57) ABSTRACT

The present invention relates to the field of security inks suitable for printing machine readable security features on substrate, security documents or articles as well as machine readable security feature made from said security inks, and security documents comprising a machine readable security feature made from said security inks. In particular, the invention provides security inks comprising one or more IR absorbing materials wherein said security ink allows the production of a machine readable security feature having the following optical properties: a lightness L* equal to or higher than about 80, a chroma C* smaller than or equal to about 15 and a reflectance at 900 nm smaller than or equal to about 60%.

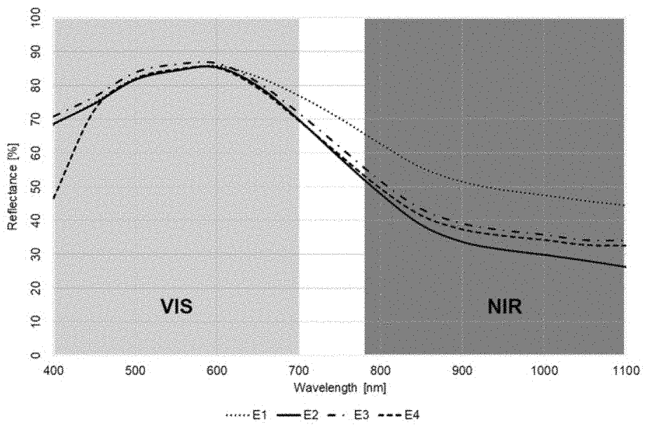

The present invention relates to the field of security inks suitable for printing machine readable security features on substrate, in particular on security documents or articles.

### BACKGROUND OF THE INVENTION

With the constantly improving quality of color photocopies and printings and in an attempt to protect security documents such as banknotes, value documents or cards, transportation tickets or cards, tax banderols, and product labels that have no reproduceable effects against counterfeiting, falsifying or illegal reproduction, it has been the conventional practice to incorporate various security features in these documents.

Security features, e.g. for security documents, can be classified into “overt” and “covert” security features. Overt security features are easily detectable with the unaided human senses, e.g. such features may be visible and/or detectable via the tactile senses while still being difficult to produce and/or to copy, whereas covert security features typically require specialized equipment and knowledge for their detection.

Machine readable inks, such as for example magnetic inks, luminescent inks and infrared (IR) absorbing inks, have been widely used in the field of security documents, in particular for banknotes printing, to produce covert security features. In the field of security and protecting value documents and value commercial goods against counterfeiting, falsifying and illegal reproduction, it is known in the art to apply machine readable security inks by different printing processes including printing processes using highly viscous or pasty inks such as offset printing, letterpress printing and intaglio printing (also referred in the art as engraved steel die or copper plate printing), liquid inks such as rotogravure printing, flexography printing, screen printing and inkjet printing.

Security features comprising infrared (IR) absorbing materials are widely known and used in security applications. Commonly used IR absorbing materials in the field of security are based on the absorption of electromagnetic radiation due to electronic transitions in a spectral range between 780 nm and 1400 nm (range provided by CIE (Commission Internationale de l'Eclairage)), this part of the electromagnetic spectrum being usually referred to as the NIR-domain. For example, IR absorbing features have been implemented in banknotes for use by automatic currency processing equipment, in banking and vending applications (automatic teller machines, automatic vending machines, etc.), in order to recognize a determined currency and to verify its authenticity, in particular to discriminate it from replicas made by color copiers. IR absorbing materials include organic compounds, inorganic materials, glasses comprising substantial amounts of IR-absorbing atoms, ions or molecules. Typical examples of IR absorbing compounds include among others carbon black, quinone-diimmonium or ammonium salts, polymethines (e.g. cyanines, squaraines, croconaines), phthalocyanine or naphthalocyanine type (IR-absorbing pi-system), dithiolenes, quaterrylene diimides, metal salts, metal oxides and metal nitrides.

Due to its strong absorption in the visible domain, carbon black is not a preferred security material since said strong absorption limits the freedom for realizing designs of a security document to be protected against counterfeit or illegal reproduction.

Ideally, security features comprising infrared (IR) absorbing materials for authentication purposes should not absorb in the visible range (400 nm to 700 nm), such as to allow its use in all types of visibly colored inks and also in markings which are invisible or partially visible to the naked eye, and at the same time display a strong absorption in the infrared or near-infrared range, such as to allow its easy recognition by standard currency processing equipment.

Organic NIR absorbers are usually of limited use in security applications because of their inherent low thermal stability, low lightfastness and the complexity of their production.

Inorganic IR absorbing compounds exhibiting improved properties have been disclosed in WO 2007/060133 A2. WO 2007/060133 A2 discloses intaglio printing inks comprising an IR absorbing material consisting of a transition element compound whose IR-absorption is a consequence of electronic transitions within the d-shell of transition element atoms or ions.

Therefore, a need remains for liquid security inks comprising one or IR absorbing materials for printing machine readable security features, which have advantages over the prior art and are similarly suitable or even more suitable than known absorbers in terms of the absorption of IR radiation and at the same time have high chemical stability and high reflectance in the visible range.

### SUMMARY

Accordingly, it is an object of the present invention to overcome the deficiencies of the prior art as discussed above.

In a first aspect, the present invention provides a security ink for printing a machine readable security feature, said security ink comprising one or more IR absorbing materials, said IR absorbing materials comprising one or more transition elements selected from the group consisting of Ti, V, Cr, Mn, Fe, Co, Ni, and Cu and one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates, silicates (SiO₄⁴⁻), condensed polysilicates; titanates (TiO₃²⁻), condensed polytitanates, vanadates (VO₄³⁻), condensed polyvanadates, molybdates (MoO₄²⁻), condensed molybdates, tungstates (WO₄²⁻), condensed polytungstates, niobates (NbO₃²⁻), fluorides (F⁻), chlorides (Cl⁻), sulfates (SO₄²⁻), hydroxides (OH⁻), and mixtures thereof,

wherein the security ink has a viscosity between about 10 mPa s and about 3000 mPa s at 25° C. (the viscosity value being measured with the method described herein), and

wherein said security ink allows the production of a machine readable security feature having the following optical properties: a lightness L* equal to or higher than about 80 (preferably equal to or higher than about 85 and more preferably equal to or higher than about 90), a chroma C* smaller than or equal to about 15 (preferably smaller than or equal to about 10) and a reflectance at 900 nm smaller than or equal to about 60% (preferably smaller than or equal to about 55% and more preferably smaller than or equal to about 45%).

Also described and claimed therein are machine readable security feature made from the security ink described herein and having the following optical properties: a lightness L* equal to or higher than about 80 (preferably equal to or higher than about 85 and more preferably equal to or higher than about 90), a chroma C* smaller than or equal to about 15 (preferably smaller than or equal to about 10) and a reflectance at 900 nm smaller than or equal to about 60% (preferably smaller than or equal to about 55% and more preferably smaller than or equal to about 45%).

Also described and claimed therein are methods for producing the machine readable security features described herein, wherein said methods comprise a step a) of applying, preferably by a printing process selected from the group consisting of screen printing, flexography printing, rotogravure printing and inkjet printing, the security ink described herein onto a substrate.

Also described and claimed therein are security documents comprising the machine readable security feature described herein.

Also described and claimed therein are methods for authenticating the security document described herein, said methods comprising the steps of:
a) providing the security document described herein and comprising the machine readable security feature made of the ink described herein;
b) illuminating the machine readable security feature at at least one wavelength, or illuminating the machine readable security feature at at least two wavelengths, wherein one of said at least two wavelengths is in the visible range and another one of said at least two wavelengths is in the IR range,
c) detecting the optical characteristics of the machine readable security feature through sensing of light reflected or transmitted by said machine readable security feature at at least one wavelength, or detecting the optical characteristics of the machine readable security feature through sensing of light reflected or transmitted by said machine readable security feature at at least two wavelengths, wherein one of said at least two wavelengths is in the visible range and another one of said at least two wavelengths is in the IR range, and
d) determining the security document authenticity from the detected optical characteristics of the machine readable security feature.

The security inks described herein for printing the machine readable security features described herein exhibit the following advantages over the intaglio inks containing the IR-absorbing compounds described in WO 2007/060133 A2:

the viscosity of said inks (10-3000 mPa s at 25° C. is much lower than the typical viscosity of an intaglio ink, thus making them printable with a wide variety of printing methods (in particular inkjet, flexography, rotogravure and screen printing) and thus provide more freedom and choices to the security printers; intaglio designs are typically made of lines having varying height and varying width, which may detrimentally affect the machine readability of the security feature or need sophisticated IR detectors or strict design limitations in terms of lines height, width and spacing. The security inks described herein may be printed as flat area having a security ink layer of about constant thickness, making machine readability of said security features easier and faster;

as a consequence of the optical properties (lightness L* equal to or higher than about 80, chroma C* smaller than or equal to about 15 and a reflectance at 900 nm smaller than or equal to about 60%) of the machine readable security features prepared with the security inks described herein, in particular colorless properties, said machine readable security features may be disposed at any place on the security document and have any desired shape without interfering with the overall design of said document. The security features may be printed e.g. as a code (such as a 1D-code or a QR code), either identical within a given series (when printed with printing methods that need a fixed printing design such as flexography, rotogravure or screen printing) or suitable for serialization (when printed with inkjet). Such designs are usually not valued by banknote or security document designers because of their visual unattractiveness; as a consequence of the optical properties (lightness L* equal to or higher than about 80, chroma C* smaller than or equal to about 15 and a reflectance at 900 nm smaller than or equal to about 60%) of the machine readable security features prepared with the security inks described herein, said machine readable security features made of the colorless security ink of the invention may be sufficiently transparent, when the ink layer is thin enough, to be printed on a window such as those present on an increasing number of banknotes, without affecting the visual appearance of said window, while allowing readability in transmission;

depending on the printing method (especially with rotogravure and screen printing), a thick layer of the security ink described herein with a high loading of the one or more IR-absorbing compounds described herein is achievable, leading to strong machine-readable signals that make high-speed sorting very reliable, even when the overall area of the security feature is small;

the machine readable security features prepared with the security inks described herein may be printed at an early stage, such as e.g. on the substrate prior to any further printing step. If inks printed subsequently are IR-transparent (such as offset, intaglio or iridescent inks), they may be used to further conceal the machine readable security feature described herein within the overall design of the security document and/or to protect it e.g. from wear due to circulation, thus extending the lifespan of the security feature. This is particularly useful if the machine readable security feature is printed as a code, for the reasons mentioned hereabove.

### BRIEF DESCRIPTION OF DRAWINGS

The sole FIGURE shows the reflectance curves in the visible range and the NIR range of a machine readable security feature produced by a printing process with the water-based thermal drying flexography printing security ink (E1), the solvent-based thermal drying rotogravure printing security ink (E2) and the solvent-based thermal drying screen printing security ink (E3) and the UV-Vis curable screen printing security (E4) described in the experimental part, said security inks independently comprising copper hydroxide phosphate Cu₂PO₄(OH) having the libethenite crystal structure as IR-absorbing material.

### DETAILED DESCRIPTION

The following definitions are to be used to interpret the meaning of the terms discussed in the description and recited in the claims.

As used herein, the article “a” indicates one as well as more than one and does not necessarily limit its referent noun to the singular.

As used herein, the terms “about” means that the amount or value in question may be the value designated or some other value about the same. The phrases are intended to convey that similar values within a range of ±5% of the indicated value promote equivalent results or effects according to the invention.

As used herein, the term “and/or” or “or/and” means that either all or only one of the elements of said group may be present. For example, “A and/or B” shall mean “only A, or only B, or both A and B”.

As used herein, the term “at least” is meant to define one or more than one, for example one or two or three.

The term “security document” refers to a document which is usually protected against counterfeit or fraud by at least one security feature. Examples of security documents include without limitation value documents and value commercial goods.

The expression “ultraviolet” (UV) is used to designate the spectral range between 100 and 400 nm, “visible” (Vis) is used to designate the spectral range between 400 and 700 nm, “infrared” (IR) is used to designate the spectral range between 780 nm and 15000 nm wavelength, and near infrared (NIR) is used to designate the spectral range between 780 nm and 1400 nm wavelength (ranges provided by CIE (Commission Internationale de l'Eclairage), cited in Sliney D. H., Eye (the Scientific Journal of the Royal College of Ophthalmologists, 2016, 30(2), pages 222-229).

The present invention provides security inks comprising the one or more IR absorbing materials described therein for printing machine readable security features. As used herein, the term “machine readable security feature” refers to an element which exhibits at least one distinctive property which is detectable by a device or machine and which can be comprised in a layer so as to confer a way to authenticate said layer or article comprising said layer by the use of a particular equipment for its authentication. The machine readable properties of the security feature described herein are embodied by the one or more absorbing materials described herein that are comprised in the security ink described herein.

The machine readable security features comprising the one or more IR absorbing materials described herein advantageously exhibit high reflectance in the visible range and low reflectance in the infrared or near-infrared range, thus allowing an efficient authentication and recognition by a standard equipment and standard detectors including those featuring high-speed banknote sorting machines, since such detectors rely on the reflectance difference at selected wavelengths in the Vis and the IR ranges. In particular, the security inks described herein allow the production of colorless or slightly colored machine readable security features, i.e. colored machine readable security features having the following optical properties: a lightness L* equal to or higher than about 80 (preferably equal to or higher than about 85 and more preferably equal to or higher than about 90), a chroma C* smaller than or equal to about 15 (preferably smaller than or equal to about 10) and a reflectance at 900 nm smaller than or equal to about 60% (preferably smaller than or equal to about 55% and more preferably smaller than or equal to about 45%). As described herein, lightness L* and chroma C* of said machine readable security features are calculated from the measurement of the L*a*b* values of the machine readable security features according to CIELAB (1976), a* and b* being the color coordinates in a Cartesian 2-dimensional space (a*=color value along the red/green axis and b*=color value along the blue/yellow axis), wherein L*a*b* values are independently obtained with a spectrophotometer DC 451R from Datacolor (measurement geometry: 45/0°; spectral analyzer: proprietary dual channel holographic grating. 256-photodiode linear arrays used for both reference and sample channels; light source: total bandwidth LED illumination). The substrate must have a higher IR reflectance than the machine readable security feature in order not to affect the measured values (this is true for most of non-colored security substrates). From each data point, the C* and h value were calculated according to the following equations: C*=\sqrt{(a*)²+(b*)²} and

$${h}^{*} ( rad ) = arc tan ( \frac{{b}^{*}}{{a}^{*}} ) + n π ,$$

wherein the value of n depends on which quadrant of the color sphere the coordinate (a*, b*) is positioned. For example, if a* is positive and b* is negative (4^{th} quadrant), the hue h in radians will be between 0 and −π/2 (n=0), whereas if a* is negative and b* is positive (2^{nd} quadrant), it will be between π/2 and π (n=1). By definition, h values are given in degrees (°) and are always positive (in the example above, it means that, when a* is positive and b* is negative, the indicated h values will be between 270° and 360°).

As described herein, reflectance at 900 nm of the machine readable security features described herein may be measured with a spectrophotometer DC45IR from Datacolor, wherein 100% reflectance is measured using the internal standard of the device.

The present invention further provides the use of the one or more IR absorbing materials described herein as machine readable compounds in the security inks described herein for printing machine readable security features on the substrates described herein by a printing process preferably selected from the group consisting of screen printing, flexography printing, rotogravure printing and inkjet printing (preferred inkjet printing processes include flextensional inkjet processes).

The security inks described herein have a viscosity between about 10 mPa s and about 3000 mPa s. In particular, the suitable viscosity range depends on the printing method used to prepare the machine readable security feature described herein: screen printing inks have a viscosity between about 50 mPa s and about 3000 mPa s at 25° C., flexography inks have a viscosity between about 50 mPa s and about 500 mPa s at 25° C., rotogravure inks have a viscosity between about 50 mPa s and about 1000 mPa s at 25° C. and inkjet inks have a viscosity between about 10 mPa s and about 50 mPa s at 25° C., wherein the viscosity measurements for security inks having a viscosity value between 100 mPa s and 3000 mPa s are carried out with a Brookfield viscometer (model “RVDV-I Prime”), the spindle and rotation speed (rpm) being adapted according to the following viscosity ranges: spindle 21 at 100 rpm for viscosity values between 100 and 500 mPa s; spindle 27 at 100 rpm for viscosity values between 500 mPa s and 2000 mPa s; and spindle 27 at 50 rpm for viscosity values between 2000 mPa s and 3000 mPa s and wherein the viscosity measurements for security inks having a viscosity value between 10 mPa s and 100 mPa s are carried out with a rotational viscosimeter DHR-2 from TA Instruments, having a cone-plane geometry and a diameter of 40 mm, at 25° C. and 1000 s⁻¹.

The one or more IR absorbing materials described herein are preferably present in the security ink described herein in an amount from about 5 to about 60 wt-%, more preferably in an amount from about 10 to about 35 wt-%, the weight percents being based on the total weight of the security ink.

The one or more IR absorbing materials described herein are independently characterized by having a specific particle size. Herein the term “size” denotes a statistical property of the IR absorbing materials described herein. As known in the art, each of said one or more IR absorbing materials can be independently characterized by measuring a particle size distribution (PSD) of a sample. Such PSDs typically describe the fractional amount (relative to total number, weight or volume) of particles in the sample as a function of a size-related characteristic of individual particles. A commonly used size-related characteristic describing individual particles is the “circle equivalent” (CE) diameter, which corresponds to the diameter of a circle that would have the same area as an orthographic projection of the material. In this application, the following values are reported:

d(v,50) (hereafter abbreviated as d50 is the value of the CE diameter, in microns, which separates the PSD in two parts of equal cumulated volume: the lower part represent 50% of the cumulated volume of all particles, corresponding to those particles with a CE diameter smaller than d50; the upper part represents 50% of the cumulated volume of particles, corresponding to those particles with a CE diameter larger than d50. D50 is also known as the median of the volume distribution of particles,

d(v,98) (hereafter abbreviated as d98 is the value of the CE diameter, in microns, which separates the PSD into two parts with different cumulated volumes such that the lower part represents 98% of the cumulated volume of all particles, corresponding to those particles with a CE diameter smaller than d98, and the upper part represents 2% of the cumulated volume of particles, with a CE diameter larger than d98.

Each of the one or more IR absorbing materials described herein preferably has a median particle size (d50 value) from about 0.01 μm to about 50 μm, more preferably from about 0.1 μm to about 20 μm and even more preferably from about 1 μm to about 10 μm, and/or has a particle size (d98 value) from about 0.1 μm to about 100 μm, more preferably from about 1 μm to about 50 μm and even more preferably from about 5 μm to about 40 μm. A variety of experimental methods are available to measure PSDs including without limitation sieve analysis, electrical conductivity measurements (using a Coulter counter), laser diffractometry (e.g. Malvern Mastersizer), acoustic spectroscopy (e.g. Quantachrome DT-100), differential sedimentation analysis (e.g. CPS devices), and direct optical granulometry. The d50 and d98 values provided therein have been measured by laser diffractometry with the following conditions: instrument: (Cilas 1090); sample preparation: the IR absorbing material was added to distilled water, until the laser obscuration reached the operating level of 13-15%, and the measurement was performed according to the ISO norm 13320.

The one or more IR absorbing materials described herein are suitable for producing machine readable security features. The one or more IR absorbing materials described herein comprise one or more transition element compounds and their infrared absorption is a consequence of electronic transitions within the d-shell of transition element atoms or ions. The one or more IR absorbing materials described herein comprise one or more transition elements selected from the group consisting of Ti, V, Cr, Mn, Fe, Co, Ni, and Cu. Preferably, the one or more IR absorbing materials described herein comprise one or more transition elements selected from the group consisting of Fe, Ni and Cu, more preferably iron and Cu and still more preferably Cu. The one or more IR absorbing materials described herein comprise one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates, silicates (SiO₄⁴⁻), condensed polysilicates; titanates (TiO₃²⁻), condensed polytitanates, vanadates (VO₄³⁻), condensed polyvanadates, molybdates (MoO₄²⁻), condensed molybdates, tungstates (WP₄²⁻), condensed polytungstates, niobates (NbO₃²⁻), fluorides (F⁻), chlorides (Cl⁻), sulfates (SO₄²⁻), hydroxides (OH⁻).

Preferably, the one or more IR absorbing materials described herein comprise one or more transition elements selected from the group consisting of Fe and Cu and one or more anions selected from the group consisting of phosphates (PO₄³⁻), hydrogenophosphates (HPO₄²⁻), pyrophosphates (P₂O₇⁴⁻), metaphosphates (P₃O₉³⁻), fluorides (F⁻), chlorides (Cl⁻), sulfates (SO₄²⁻) and hydroxides (OH⁻) such as for example copper(II) fluoride (CuF₂), copper hydroxyfluoride (CuFOH), copper hydroxide (Cu(OH)₂), copper phosphate hydrate (Cu₃(PO₄)₂*2H₂O), anhydrous copper phosphate (Cu₃(PO₄)₂), basic copper(II) phosphates (e.g. Cu₂PO₄(OH), Cu₃(PO₄)(OH)₃, “Cornetite”, Cu₅(PO₄)₃(OH)₄, “Pseudomalachite”, CuAl₆(PO₄)₄(OH)₈•5H₂O “Turquoise”, etc.), copper (II) pyrophosphate (Cu₂(P₂O₇)*3H₂O), anhydrous copper(II) pyrophosphate (Cu₂(P₂O₇)), copper(II) metaphosphate (Cu(PO₃)₂, more correctly written as Cu₃(P₃O₉)₂), iron(II) fluoride (FeF₂*4H₂O), anhydrous iron(II) fluoride (FeF₂), iron(II) phosphate (Fe₃(PO₄)₂*8H₂O, “Vivianite”), lithium iron(II) phosphate (LiFePO₄, “Triphylite”), sodium iron(II) phosphate (NaFePO₄, “Maricite”), iron(II) silicates (Fe₂SiO₄, “Fayalite”; FexMg₂xSiO₄, “Olivine”), iron(II) carbonate (FeCO₃, “Ankerite”, “Siderite”). More preferably, the one or more IR absorbing materials described herein comprise Cu as transition element and one or more anions selected from the group consisting of phosphates (PO₄³⁻), hydrogenophosphates (HPO₄²⁻), pyrophosphates (P₂O₇⁴−), metaphosphates (P₃O₉³⁻), polyphosphates and hydroxides (OH), still more preferably one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates and hydroxides (OH⁻). According to a preferred embodiment, at least one of the one or more IR absorbing materials described herein is Cu₂PO₄(OH) (CAS No: 12158-74-6) preferably Cu₂PO₄(OH) having the libethenite crystal structure.

The security inks described herein may be UV-curable inks or thermal drying inks. According to one embodiment, the security inks described herein are UV-curable inks or solvent-based thermal drying inks since said inks advantageously exhibit low reflectance in the infrared or near-infrared range.

The security inks described herein are particularly suitable to be applied by a printing process selected form the group consisting of screen printing processes, flexography processes, rotogravure processes, and inkjet printing processes (preferred inkjet printing processes include flextensional inkjet processes) onto a substrate such as those described herein.

Screen printing (also referred in the art as silkscreen printing) is a printing technique that typically uses a screen made of woven mesh to support an ink-blocking stencil. The attached stencil forms open areas of mesh that transfer ink as a sharp-edged image onto a substrate. A squeegee is moved across the screen with ink-blocking stencil, forcing ink past the threads of the woven mesh in the open areas. Generally, a screen is made of a piece of porous, finely woven fabric called mesh stretched over a frame of e.g. aluminum or wood. Currently most meshes are made of man-made materials such as synthetic or steel threads. Preferred synthetic materials are nylon or polyester threads.

In addition to screens made on the basis of a woven mesh based on synthetic or metal threads, screens have been developed out of a solid metal sheet with a grid of holes. Such screens are prepared by a process comprising of electrolytically forming a metal screen by forming in a first electrolytic bath a screen skeleton upon a matrix provided with a separating agent, stripping the formed screen skeleton from the matrix and subjecting the screen skeleton to an electrolysis in a second electrolytic bath in order to deposit metal onto said skeleton.

There are three types of screen printing presses, namely flat-bed, cylinder and rotary screen printing presses. Flat-bed and cylinder screen printing presses are similar in that both use a flat screen and a three-step reciprocating process to perform the printing operation. The screen is first moved into position over the substrate, the squeegee is then pressed against the mesh and drawn over the image area, and then the screen is lifted away from the substrate to complete the process. With a flat-bed press the substrate to be printed is typically positioned on a horizontal print bed that is parallel to the screen. With a cylinder press the substrate is mounted on a cylinder. Flat-bed and cylinder screen printing processes are discontinuous processes, and consequently limited in speed which is generally at maximum 45 m/min in web or 3'000 sheets/hour in a sheet-fed process.

Conversely, rotary screen presses are designed for continuous, high speed printing. The screens used on rotary screen presses are for instance thin metal cylinders that are usually obtained using the electroforming method described hereabove or made of woven steel threads. The open-ended cylinders are capped at both ends and fitted into blocks at the side of the press. During printing, ink is pumped into one end of the cylinder so that a fresh supply is constantly maintained. The squeegee is fixed inside the rotating screen and squeegee pressure is maintained and adjusted to allow a good and constant print quality. The advantage of rotary screen presses is the speed which can reach easily 150 m/min in web or 10'000 sheets/hour in a sheet-fed process.

Screen printing is further described for example in The Printing Ink Manual, R. H. Leach and R. J. Pierce, Springer Edition, 5^{th} Edition, pages 58-62, in Printing Technology, J. M. Adams and P. A. Dolin, Delmar Thomson Learning, 5^{th} Edition, pages 293-328 and in Handbook of Print Media, H. Kipphan, Springer, pages 409-422 and pages 498-499.

Screen printing security inks are known in the art as requiring a low viscosity. Typically, security inks suitable for screen printing processes have a viscosity in the range from about 50 mPa s to about 3000 mPa s, preferably in the range from about 100 mPa s to about 2500 mPa s, more preferably from about 200 mPa s to about 2000 mPa s, at 25° C. (using for example a Brookfield machine “RVDV-I Prime”, spindle 21 at 100 rpm, spindle 27 at 100 rpm or spindle 27 at 50 rpm).

Screen printing security inks allows the preparation of the machine readable security feature described herein (i.e. dried or cured security ink layer) having a value typically between about 3 μm and about 10 μm when a thermal drying screen printing security ink is used and typically between about 10 μm and about 30 μm when a UV curable screen printing security ink is used.

Flexography printing methods preferably use a unit with a chambered doctor blade, an anilox roller and plate cylinder. The anilox roller advantageously has small cells whose volume and/or density determines the protective varnish application rate. The chambered doctor blade lies against the anilox roller, filling the cells and scraping off surplus protective varnish at the same time. The anilox roller transfers the ink to the plate cylinder which finally transfers the ink to the substrate. Plate cylinders can be made from polymeric or elastomeric materials. Polymers are mainly used as photopolymer in plates and sometimes as a seamless coating on a sleeve. Photopolymer plates are made from light-sensitive polymers that are hardened by ultraviolet (UV) light. Photopolymer plates are cut to the required size and placed in an UV light exposure unit. One side of the plate is completely exposed to UV light to harden or cure the base of the plate. The plate is then turned over, a negative of the job is mounted over the uncured side and the plate is further exposed to UV light. This hardens the plate in the image areas. The plate is then processed to remove the unhardened photopolymer from the non-image areas, which lowers the plate surface in these non-image areas. After processing, the plate is dried and given a post-exposure dose of UV light to cure the whole plate. Preparation of plate cylinders for flexography is described in Printing Technology, J. M. Adams and P. A. Dolin, Delmar Thomson Learning, 5^{th} Edition, pages 359-360.

Flexography printing security inks are known in the art as requiring a low viscosity. Typically, security inks suitable for flexography processes have a viscosity in the range of about 50 mPa s to about 500 mPa s at 25° C. (using for example a Brookfield machine “RVDV-I Prime”, spindle 21 at 100 rpm).

Flexography printing security inks allows the preparation of the machine readable security feature described herein (i.e. dried or cured security ink layer) having a value typically between about 1 and about 6 μm when a thermal drying flexography printing security ink is used and typically between about 2 and about 13 μm when a UV curable flexography printing security ink is used.

The term rotogravure refers to a printing process which is described for example in “Handbook of print media”, Helmut Kipphan, Springer Edition, page 48. As known by those skilled in the art, rotogravure is a printing process wherein image elements are engraved into the surface of the cylinder. The non-image areas are at a constant original level. Prior to printing, the entire printing plate (non-printing and printing elements) is inked and flooded with ink. Ink is removed from the non-image by a wiper or a blade before printing, so that ink remains only in the cells. The image is transferred from the cells to the substrate by a pressure typically in the range of 2 to 4 bars and by the adhesive forces between the substrate and the ink. The term rotogravure does not encompass intaglio printing processes (also referred in the art as engraved steel die or copper plate printing processes) which rely for example on a different type of ink.

Rotogravure printing security inks are known in the art as having a low viscosity. Typically, security inks suitable for rotogravure printing processes have a viscosity in the range of about 50 mPa s to about 1000 mPa s at 25° C. (using for example a Brookfield machine model “RVDV-I Prime”, spindle 21 at 100 rpm or spindle 27 at 100 rpm).

Rotogravure printing security inks allows the preparation of the machine readable security feature described herein (i.e. dried or cured security ink layer) having a value typically between about 1 μm and about 10 μm when a thermal drying rotogravure printing security ink is used and typically between about 2 μm and about 18 μm when a UV curable rotogravure printing security ink is used.

Flextensional inkjet printing is an inkjet printing using a flextensional inkjet print head structure. Usually, flextensional transducers include a body or substrate, a flexible membrane having an orifice defined therein, and an actuator. The substrate defines a reservoir for holding a supply of flowable material and the flexible membrane has a circumferential edge supported by the substrate. The actuator may either be piezoelectric (i.e. it includes a piezoelectric material which deforms when an electrical voltage is applied), or thermally activated, such as described for example in U.S. Pat. No. 8,226,213. As such, when the material of the actuator deforms, the flexible membrane deflects causing a quantity of flowable material to be ejected from the reservoir through the orifice. Flextensional print head structures are described in U.S. Pat. No. 5,828,394, wherein a fluid ejector is disclosed which includes one wall including a thin elastic membrane having an orifice defining a nozzle and elements responsive to electrical signals for deflecting the membrane to eject drops of fluid from the nozzle. Flextensional print head structures are described in U.S. Pat. No. 6,394,363, wherein the disclosed uses for example excitation of the surface layers incorporating nozzles which are arranged over one surface layer with addressability, forming a liquid projection array, capable of operation at high frequencies with a wide range of liquids. Flextensional print head structures are also described in U.S. Pat. No. 9,517,622, which describes a liquid droplet forming apparatus comprising a film member configured to be vibrated so as to eject liquid held in a liquid holding unit, wherein a nozzle is formed in the film member. Further it is provided a vibrating unit to vibrate the film member; and a driving unit to selectively apply an ejection waveform and a stirring waveform to the vibrating unit. Flextensional print head structures are also described in U.S. Pat. No. 8,226,213 which describes a method of actuating a thermal bend actuator having an active beam fused to a passive beam. The method comprises passing an electrical current through the active beam so as to cause thermoelastic expansion of the active beam relative to the passive beam and bending of the actuator.

Flextensional inkjet printing security inks are known in the art as having a very low viscosity. Typically, security inks suitable for flextensional inkjet printing processes have viscosity in the range of about 10 mPa s to about 50 mPa s (using for example a rotational viscosimeter DHR-2 from TA Instruments, having a cone-plane geometry and a diameter of 40 mm, at 25° C. and 1000 s⁻¹).

The thickness of the machine readable security feature described herein (i.e. dried or cured security ink layer) prepared by flextensional inkjet printing essentially depends on the particle size of the one or more IR-absorbing compound and is preferably between about 0.05 μm and about 10 μm (dried or cured ink layer), more preferably between about 0.1 μm and about 5 μm, and even more preferably between about 0.5 μm and about 2 μm.

According to one embodiment, the security inks described herein are UV-curable inks comprising one or more photoinitiators, wherein said one or more photoinitiators are preferably in an amount from about 0.1 wt-% to about 20 wt-%, more preferably in an amount from about 1 wt-% to about 15 wt-%, the weight percents being based on the total weight of the security ink.

Preferably, the UV-Vis curable security inks described herein comprise one or more UV curable compounds being monomers and oligomers selected from the group consisting of radically curable compounds and cationically curable compounds. The security inks described herein comprise described herein may be a hybrid system and comprise a mixture of one or more cationically curable compounds and one or more radically curable compounds. Cationically curable compounds are cured by cationic mechanisms typically including the activation by radiation of one or more photoinitiators which liberate cationic species, such as acids, which in turn initiate the curing so as to react and/or cross-link the monomers and/or oligomers to thereby cure the security ink. Radically curable compounds are cured by free radical mechanisms typically including the activation by radiation of one or more photoinitiators, thereby generating radicals which in turn initiate the polymerization so as to cure the security ink.

Preferably, the UV-Vis curable security ink described herein comprises one or more cationically curable oligomers (also referred in the art as prepolymers) selected from the group consisting of oligomeric (meth)acrylates, vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof. More preferably, the UV-Vis curable security ink described herein comprises one or more oligomers selected from the group consisting of oligomeric (meth)acrylates, vinyl ethers, propenyl ethers, cyclic ethers such as epoxides, oxetanes, tetrahydrofuranes, lactones and mixtures thereof. Typical examples of epoxides include without limitation glycidyl ethers, β-methyl glycidyl ethers of aliphatic or cycloaliphatic diols or polyols, glycidyl ethers of diphenols and polyphenols, glycidyl esters of polyhydric phenols, 1,4-butanediol diglycidyl ethers of phenolformaldehyde novolak, resorcinol diglycidyl ethers, alkyl glycidyl ethers, glycidyl ethers comprising copolymers of acrylic esters (e.g. styrene-glycidyl methacrylate or methyl methacrylate-glycidyl acrylate), polyfunctional liquid and solid novolak glycidyl ethers resins, polyglycidyl ethers and poly(β-methylglycidyl) ethers, poly(N-glycidyl) compounds, poly(S-glycidyl) compounds, epoxy resins in which the glycidyl groups or β-methyl glycidyl groups are bonded to hetero atoms of different types, glycidyl esters of carboxylic acids and polycarboxylic acids, limonene monoxide, epoxidized soybean oil, bisphenol-A and bisphenol-F epoxy resins. Examples of suitable epoxides are disclosed in EP 2 125 713 B1. Suitable examples of aromatic, aliphatic or cycloaliphatic vinyl ethers include without limitation compounds having at least one, preferably at least two, vinyl ether groups in the molecule. Examples of vinyl ethers include without limitation triethylene glycol divinyl ether, 1,4-cyclohexanedimethanol divinyl ether, 4-hydroxybutyl vinyl ether, propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetraethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester. Examples of hydroxy-containing compounds include without limitation polyester polyols such as for example polycaprolactones or polyester adipate polyols, glycols and polyether polyols, castor oil, hydroxy-functional vinyl and acrylic resins, cellulose esters, such as cellulose acetate butyrate, and phenoxy resins. Further examples of suitable cationically curable compounds are disclosed in EP 2 125 713 B1 and EP 0 119 425 B1.

According to one embodiment of the present invention, the UV-Vis curable security inks described herein comprise one or more radically curable oligomeric compounds selected from (meth)acrylates, preferably selected from the group consisting of epoxy (meth)acrylates, (meth)acrylated oils, polyester (meth)acrylates, aliphatic or aromatic urethane (meth)acrylates, silicone (meth)acrylates, amino (meth)acrylates, acrylic (meth)acrylates and mixtures thereof. The term “(meth)acrylate” in the context of the present invention refers to the acrylate as well as the corresponding methacrylate. The components of the UV-Vis curable security inks described herein comprise may be prepared with additional vinyl ethers and/or monomeric acrylates such as for example trimethylolpropane triacrylate (TMPTA), pentaerytritol triacrylate (PTA), tripropyleneglycoldiacrylate (TPGDA), dipropyleneglycoldiacrylate (DPGDA), hexanediol diacrylate (HDDA) and their polyethoxylated equivalents such as for example polyethoxylated trimethylolpropane triacrylate, polyethoxylated pentaerythritol triacrylate, polyethoxylated tripropyleneglycol diacrylate, polyethoxylated dipropyleneglycol diacrylate and polyethoxylated hexanediol diacrylate.

Alternatively, the UV-Vis curable security ink described herein is a hybrid ink and may be prepared from a mixture of radically curable compounds and cationically curable compounds such as those described herein.

As mentioned above, UV-Vis curing of a monomer, oligomer requires the presence of one or more photoinitiators and may be carried out in a number of ways. As mentioned herein and as known by those skilled in the art, the UV-Vis curable security ink described herein to be cured and hardened on a substrate such as those described herein comprises one or more photoinitiators optionally with one or more photosensitizers, said one or more photoinitiators and optional one or more photosensitizers being selected according to its/their absorption spectrum/spectra in correlation with the emission spectrum of the radiation source. Depending on the degree of transmission of the electromagnetic radiation through the substrate, hardening of the security ink may be obtained by increasing the irradiation time. However, depending on the substrate material, the irradiation time is limited by the substrate material and its sensitivity to the heat produced by the radiation source.

Depending on the monomers, oligomers or prepolymers used in the UV-Vis curable security ink described herein, different photoinitiators might be used. Suitable examples of free radical photoinitiators are known to those skilled in the art and include without limitation acetophenones, benzophenones, benzyldimethyl ketals, alpha-aminoketones, alpha-hydroxyketones, phosphine oxides and phosphine oxide derivatives, as well as mixtures of two or more thereof. Suitable examples of cationic photoinitiators are known to those skilled in the art and include without limitation onium salts such as organic iodonium salts (e.g. diary) iodoinium salts), oxonium (e.g. triaryloxonium salts) and sulfonium salts (e.g. triarylsulfonium salts), as well as mixtures of two or more thereof. Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures of two or more thereof.

According to an embodiment, the UV-Vis curable security inks described herein are UV-Vis curable screen printing security inks, wherein said UV-Vis curable screen printing security inks comprise the one or more photoinitiators described herein, the one or more UV curable compounds being monomers and oligomers described herein and the optional additives or ingredients described herein.

According to an embodiment, the UV-Vis curable security inks described herein are UV-Vis curable flexography printing security inks, wherein said wherein UV-Vis curable flexography printing security inks comprise the one or more photoinitiators described herein, the one or more UV curable compounds being monomers and oligomers described herein and the optional additives or ingredients described herein.

According to an embodiment, the UV-Vis curable security inks described herein are UV-Vis curable rotogravure printing security inks, wherein said UV-Vis curable rotogravure printing security inks comprise the one or more photoinitiators described herein, the one or more UV curable compounds being monomers and oligomers described herein and the optional additives or ingredients described herein.

According to an embodiment, the UV-Vis curable security inks described herein are UV-Vis curable inkjet printing security inks, preferably flextensional inkjet printing security inks, wherein said UV-Vis curable flextensional inkjet printing security inks comprise the one or more photoinitiators described herein, the one or more UV curable compounds being monomers and oligomers described herein and the optional additives or ingredients described herein.

According to one embodiment, the security inks described herein are thermal drying inks comprising one or more solvents selected from the group consisting of organic solvents, water and mixtures thereof, wherein said one or more solvents are preferably in an amount from about 10 wt-% to about 90 wt-%, the weight percents being based on the total weight of the security ink. Thermal drying security inks consist of security inks which are dried by hot air, infrared or by a combination thereof. Thermal drying security inks typically consist of about 10 wt-% to about 90 wt-% solid content that remains on the printed substrate and about 10 wt-% to about 90 wt-% of one or more solvents which are evaporated as a result of drying.

Preferably, the organic solvents described herein are selected from the group consisting of alcohols (such as ethanol), ketones (such as methyl ethyl ketone), esters (such as ethyl acetate, propyl acetate and isopropyl acetate), glycol ethers and glycol ether esters (such as butyl glycol acetate and dipropylene glycol monomethyl ether) and mixtures thereof.

According to one embodiment, the thermal drying security inks described herein consist of water-based thermal drying security inks comprising one or more resins selected from the group consisting of polyester resins, polyether resins, polyurethane resins (e.g. carboxylated polyurethane resins), polyurethane alkyd resins, polyurethane-acrylate resins, poly(meth)acrylates resins, polyetherurethane resins, styrene acrylate resins, polyvinylalcohol resins, poly(ethylene glycol) resins, polyvinylpyrrolidone resins, polyethyleneimine resins, modified starches, cellulose esters or ethers (such as cellulose acetate and carboxymethyl cellulose), copolymers and mixtures thereof.

According to an embodiment, the thermal drying security inks described herein consist of solvent-based thermal drying security inks comprising one or more resins selected from the group consisting of nitrocelluloses, methyl celluloses, ethyl celluloses, cellulose acetates, polyvinylbutyrals, polyurethanes, poly(meth)acrylates (including without limitation poly(meth)acrylate polymers and copolymers soluble in alkaline solutions), polyamides, polyesters, polyvinyl acetates, vinyl chloride copolymers, rosin modified phenolic resins, phenolic resins, maleic resins, styrene-acrylic resins, polyketone resins, and mixtures thereof.

According to an embodiment, the thermal drying security inks described herein are thermal drying screen printing security inks, wherein said thermal drying screen printing security inks comprise the one or more solvents described herein, the one or more resins described herein and the optional additives or ingredients described herein.

According to an embodiment, the thermal drying security inks described herein are thermal drying flexography printing security inks, wherein said thermal drying screen printing security inks comprise the one or more solvents described herein, the one or more resins described herein and the optional additives or ingredients described herein.

According to an embodiment, the thermal drying security inks described herein thermal drying rotogravure printing security inks, wherein said thermal drying screen printing security inks comprise the one or more solvents described herein, the one or more resins described herein and the optional additives or ingredients described herein.

According to an embodiment, the thermal drying security inks described herein thermal drying inkjet printing security inks, preferably flextensional inkjet printing security inks, wherein said thermal drying inks comprise the one or more solvents described herein, the one or more resins described herein and the optional additives or ingredients described herein.

The security inks described herein may further comprise one or more fillers or extenders provided that these potential additional fillers or extenders do not negatively interfere with the absorption properties in the IR/NIR range spectrum of interest of the machine readable security feature and do not negatively interfere with the optical properties described herein (lightness L* equal to or higher than about 80%, chroma C* smaller than or equal to about 15 and reflectance at 900 nm smaller than or equal to about 60%) of the machine readable security feature described herein. The one or more one or more fillers or extenders described herein are preferably selected from the group consisting of carbon fibers, talcs, mica (muscovite), wollastonites, calcinated clays, china clays, kaolins, carbonates (e.g. calcium carbonate, sodium aluminum carbonate), silicas and silicates (e.g. magnesium silicate, aluminum silicate), sulfates (e.g. magnesium sulfate, barium sulfate), titanates (e.g. potassium titanate), alumina hydrates, silica, fumed silica, montmorillonites, graphites, anatases, rutiles, bentonites, vermiculites, zinc whites, zinc sulfides, wood flours, quartz flours, natural fibers, synthetic fibers and combinations thereof. Alternatively, and with the aim of not compromising the optical properties described herein (lightness L* equal to or higher than about 80%, chroma C* smaller than or equal to about 15 and reflectance at 900 nm smaller than or equal to about 60%) of the machine readable security feature described herein, microspheres or hollow spheres made of polymer (e.g. polystyrene or PMMA) or made of glass may be used as the one or more fillers or extenders. When present, the one or more fillers or extenders are preferably present in an amount from about 0.01 to 10 about wt-%, preferably from about 0.1 to about 5wt-% the weight percents being based on the total weight of the security ink.

The security inks described herein may further comprise one or more coloring agents (pigments or dyes) provided that said one or more coloring agents do not negatively interfere with the absorption properties in the IR/NIR range spectrum of interest of the machine readable security feature and do not negatively interfere with optical properties described herein (lightness L* equal to or higher than about 80%, chroma C* smaller than or equal to about 15 and reflectance at 900 nm smaller than or equal to about 60%) of the machine readable security feature described herein Alternatively, the one or more coloring agents may be used as shading additives, i.e. additives to cancel the slight color shift induced by the one or more IR-absorbing compounds or to better match the color of the substrate or underlying layer(s).

The security inks described herein may further comprise one or more iridescent pigments and/or one or more cholesteric liquid crystal pigments. Typical examples of iridescent pigments include without limitation interference coated pigments consisting of a core made of synthetic or natural micas, other layered silicates (e.g. talc, kaolin and sericite), glasses (e.g. borosilicates), silicium dioxides (SiO₂), aluminum oxides (Al₂O₃), aluminum oxides/hydroxides (boehmite), and mixtures thereof coated with one or more layers made of metal oxides (e.g. titanium oxide, zirconium oxide, tin oxide, chromium oxide, nickel oxide, copper oxide, iron oxide and iron oxide/hydroxide). The structures described hereabove have been described for example in Chem. Rev. 99 (1999), G. Pfaff and P. Reynders, pages 1963-1981 and WO 2008/083894 A2. Typical examples of these interference coated pigments include without limitation silicium oxide cores coated with one or more layers made of titanium oxide, tin oxide and/or iron oxide; natural or synthetic mica cores coated with one or more layers made of titanium oxide, silicium oxide and/or iron oxide, in particular mica cores coated with alternate layers made of silicium oxide and titanium oxide; borosilicate cores coated with one or more layers made of titanium oxide, silicium oxide and/or tin oxide; and titanium oxide cores coated with one or more layers made of iron oxide, iron oxide/hydroxide, chromium oxide, copper oxide, cerium oxide, aluminum oxide, silicium oxide, bismuth vanadate, nickel titanate, cobalt titanate and/or antimony-doped, fluorine-doped or indium-doped tin oxide; aluminum oxide cores coated with one or more layers made of titanium oxide and/or iron oxide. Cholesteric liquid crystal pigments are based on liquid crystals in the cholesteric phase exhibiting a molecular order in the form of a helical superstructure perpendicular to the longitudinal axes of its molecules. The helical superstructure is at the origin of a periodic refractive index modulation throughout the liquid crystal material, which in turn results in a selective transmission/reflection of determined wavelengths of light (interference filter effect). Cholesteric liquid crystal polymers can be obtained by subjecting one or more crosslinkable substances (nematic compounds) with a chiral phase to alignment and orientation. The particular situation of the helical molecular arrangement leads to cholesteric liquid crystal materials exhibiting the property of reflecting a circularly polarized light component within a determined wavelength range. The pitch can be tuned in particular by varying selectable factors including the temperature and solvents concentration, by changing the nature of the chiral component(s) and the ratio of nematic and chiral compounds. Crosslinking under the influence of UV radiation freezes the pitch in a predetermined state by fixing the desired helical form so that the color of the resulting cholesteric liquid crystal materials is no longer depending on external factors such as the temperature. Cholesteric liquid crystal materials may then be shaped to cholesteric liquid crystal pigments by subsequently comminuting the polymer to the desired particle size. Examples of films and pigments made from cholesteric liquid crystal materials and their preparation are disclosed in U.S. Pat. Nos. 5,211,877; 5,362,315 and 6,423,246 and in EP 1 213 338 A1; EP 1 046 692 A1 and EP 0 601 483 A1, the respective disclosure of which is incorporated by reference herein.

The security inks described herein may comprise one or more further IR-absorbers known in the art. The role of said further IR-absorbers may be to slightly modify the reflectance profile of the machine readable security feature such as to fully conform to the specifications of the detection system. Preferably, said one or more further IR-absorbers are selected from the group consisting of doped tin oxides, doped indium oxides, reduced tungsten oxides, tungsten bronzes and mixtures thereof. When present, the amount of the one or more further IR-absorbers is from about 0.5 wt-% to about 25 wt-%, the weight percents being based on the total weight of the security ink. The ratio between the one or more further IR-absorbers, when present, and the total of all IR-absorbers is preferably between about 0.1 wt-% and about 30 wt-%, and more preferably between about 1 wt-% and about 15 wt-%.

According to one embodiment, one of the one or more further IR-absorbers is doped tin oxide, wherein tin oxide is preferably doped with antimony (antimony tin oxide, ATO), wherein the antimony is present in an amount from about 0.5 to about 20 mol-%, preferably from about 2 to about 18 mol-%.

According to another embodiment, one of the one or more further IR-absorbers is doped indium oxide, wherein indium oxide is preferably doped with tin (indium tin oxide, ITO), wherein the tin is present in an amount from about 1 to about 30 mol-%, preferably from about 5 to about 15 mol-%. Preferably, reduced indium tin oxide is used as the one or more further IR-absorbers. The level of reduction is preferably between about 0.1 mol-% and about 5 mol-%, more preferably between about 0.5 mol-% and about 1 mol-%, wherein a level of reduction of 1 mol-% means that an oxygen atom has been removed from 1% of the indium tin oxide units.

According to another embodiment, one of the one or more further IR-absorbers is reduced tungsten oxide and/or one of the one or more further IR-absorbers is tungsten bronze. Reduced tungsten oxides are non-stoichiometric compounds of the general formula W_{y}O_{z} wherein the ratio z/y is smaller than 3 and greater than 2, preferably smaller than 2.99 and greater than 2.2, more preferably smaller than 2.9 and greater than 2.7. Such compounds are described for example in H. Takeda and K. Adachi, J. Am Ceram. Soc., 90 [12], 2007, p. 4059-4061, in US 2006/0178254 and US 2007/0187653.

Tungsten bronzes are non-stoichiometric compounds obtained from the stoichiometric tungsten oxide WO₃ or metal tungstate MWO₄. Tungsten bronzes of formula MₓW_{y}O_{z} are described for example in US 2006/0178254 and US 2007/0187653, wherein US 2006/0178254 discloses MₓW_{y}O_{z} whereby 0.001≤x/y≤1 and 2.2≤z/y≤3.0 and US 2007/0187653 discloses MₓW_{y}O_{z}, whereby 0.001≤x/y≤1.1 and 2.2≤z/y≤3.0 and M is at least one element selected from the group consisting of H, He, alkali metals, alkaline earth metals, rare earth elements, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi and I, preferably Na, Cs, Rb, K, Tl, In, Ba, Li, Ca, Sr, Fe and Sn.

Tungsten bronzes of formula MₓWO₃ are described for example in US 2006/0178254 and US 2007/0187653, wherein M is a metal element, such as an alkali metal, alkaline earth metal or rare earth metal and whereby 0<x<1. Such compounds, wherein M=K are also described in C. Guo et al, ACS Appl. Mater. Interfaces, 3, 2011, p. 2794-2799 and are shown to display a strong absorption beyond 900 nm.

Tungsten bronzes of formula M_{E}A_{G}W_{(1-G)}O_{J} are described for example in US 2007/0187653, where M is one or more elements selected from H, He, alkali metals, alkaline-earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I; A is one or more elements selected from Mo, Nb, Ta, Mn, V, Re, Pt, Pd, and Ti; W is tungsten; O is oxygen; and 0<E≤1.2; 0<G≤1; and 2≤J≤3.

US 201/0248225 discloses for example potassium cesium tungsten bronze solid solutions of the formula KₓCs_{y}WO_{z} where x+y≤1 and 2≤z≤3. Such compounds are shown to be strong absorbers in the range 1200-1750 nm.

The security inks described herein may further comprise one or more luminescent compounds, such as to provide a security feature with enhanced counterfeiting resistance.

The security ink described herein described herein may further comprise one or more marker substances or taggants.

The security ink described herein may further comprise one or more additives, said one or more additives including without limitation compounds and materials which are used for adjusting physical, rheological and chemical parameters of the security ink such as the consistency (e.g. anti-settling agents and plasticizers), the foaming properties (e.g. antifoaming agents and deaerators), the lubricating properties (waxes), the UV stability (photostabilizers), the adhesion properties, the surface properties (wetting agents, oleophobic and hydrophobic agents), the drying/curing properties (cure accelerators, sensitizers, crosslinkers), etc. Additives described herein may be present in the security inks described herein in amounts and in forms known in the art, including in the form of so-called nano-materials where at least one of the dimensions of the additives is in the range of 1 to 1000 nm.

The present invention further provides methods for producing the security inks described herein and security inks obtained therefrom. The security inks described herein may be prepared by dispersing or mixing the one or more IR absorbing materials described herein and all the other ingredients thus forming said inks. When the security inks described herein are UV-VIS curable security inks, the one or more photoinitiators may be added to the composition either during the dispersing or mixing step of all other ingredients or may be added at a later stage, i.e. after the formation of the inks. Varnishes, binders, resins, compounds, monomers, oligomers, resins and additives are typically chosen among those known in the art and as described hereabove and depend on the printing process used to apply the security ink described herein on the substrate described herein.

The security inks described herein are applied on the substrate described herein for producing a machine readable security feature by a printing process preferably selected from the group consisting of screen printing processes, rotogravure processes, flexography processes and inkjet printing processes (preferred inkjet printing processes include flextensional inkjet processes).

The present invention further provides methods for producing the machine readable security features described herein and machine readable security features obtained thereof. The method comprises a step a) of applying by a printing process preferably selected from the group consisting of screen printing, flexography printing, rotogravure printing and inkjet printing (preferred inkjet printing processes include flextensional inkjet processes) the security ink described herein onto the substrate described herein.

After having carried out the printing step, a step b) of drying and/or curing the security ink in the presence of UV-VIS radiation and/or air or heat is carried out so as to form the machine readable security feature described herein on the substrate, said step of drying and/or curing being performed after the step a). The time between the step a) (i.e. step a) of applying, preferably by a printing process) and the step b) (i.e. step b) of drying and/or curing) is preferably between about 0.1 sec and about 10 sec, more preferably between about 0.2 sec and about 5 sec and even more preferably between about 0.5 sec and about 2 sec.

The present invention further provides machine readable security features made of the security ink described herein on the substrate described herein.

The substrates described herein are preferably selected from the group consisting of papers or other fibrous materials (including woven and non-woven fibrous materials), such as cellulose, paper-containing materials, glasses, metals, ceramics, plastics and polymers, metallized plastics or polymers, composite materials and mixtures or combinations of two or more thereof. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. Typical examples of plastics and polymers include polyolefins such as polyethylene (PE) and polypropylene (PP) including biaxially oriented polypropylene (BOPP), polyamides, polyesters such as poly(ethylene terephthalate) (PET), poly(1,4-butylene terephthalate) (PBT), poly(ethylene 2,6-naphthoate) (PEN) and polyvinylchlorides (PVC). Spunbond olefin fibers such as those sold under the trademark Tyvek® may also be used as substrate. Typical examples of metalized plastics or polymers include the plastic or polymer materials described hereabove having a metal disposed continuously or discontinuously on their surface. Typical examples of metals include without limitation aluminum (Al), chromium (Cr), copper (Cu), gold (Au), silver (Ag), alloys thereof and combinations of two or more of the aforementioned metals. The metallization of the plastic or polymer materials described hereabove may be done by an electrodeposition process, a high-vacuum coating process or by a sputtering process. Typical examples of composite materials include without limitation multilayer structures or laminates of paper and at least one plastic or polymer material such as those described hereabove as well as plastic and/or polymer fibers incorporated in a paper-like or fibrous material such as those described hereabove. Of course, the substrate can comprise further additives that are known to the skilled person, such as fillers, sizing agents, whiteners, processing aids, reinforcing or wet strengthening agents, etc.

With the aim of further increasing the security level and the resistance against counterfeiting and illegal reproduction of security documents, the substrate described herein may contain printed, coated, or laser-marked or laser-perforated indicia, watermarks, security threads, fibers, planchettes, luminescent compounds, windows, foils, decals, primers and combinations of two or more thereof, provided that these potential additional features or elements do not negatively interfere with the absorption properties in the IR/NIR range spectrum of interest of the machine readable security feature and do not negatively interfere with optical properties described herein (lightness L* equal to or higher than about 80%, chroma C* smaller than or equal to about 15 and reflectance at 900 nm smaller than or equal to about 60%) of the machine readable security feature described herein.

With the aim of increasing the durability through soiling or chemical resistance and cleanliness and thus the circulation lifetime of security documents or with the aim of modifying their aesthetical appearance (e.g. optical gloss), one or more protective layers may be applied on top of the machine readable security features or security document described herein. When present, the one or more protective layers are typically made of protective varnishes which may be transparent or slightly colored or tinted and may be more or less glossy. Protective varnishes may be radiation curable compositions, thermal drying compositions or any combination thereof. Preferably, the one or more protective layers are made of radiation curable compositions, and more preferably of UV-Vis curable compositions.

The machine readable security features described herein may be provided directly on a substrate on which it shall remain permanently (such as for banknote applications). In some cases, the machine readable security features described herein may be produced on an auxiliary substrate such as for example for example a security thread, a security stripe, a foil, a decal, a window or a label and consequently transferred to a security document in a separate step. Alternatively, a machine readable security feature may also be provided on a temporary substrate for production purposes, from which the machine readable security feature is subsequently removed. Thereafter, after hardening/curing of the security ink described herein for the production of the machine readable security feature, the temporary substrate may be removed from the machine readable security feature.

Alternatively, in another embodiment an adhesive layer may be present on machine readable security feature or may be present on the substrate comprising the machine readable security feature described herein, said adhesive layer being on the side of the substrate opposite to the side where the machine readable security feature is provided or on the same side as the machine readable security feature and on top of the machine readable security feature. Therefore, an adhesive layer may be applied to the machine readable security feature or to the substrate, said adhesive layer being applied after the drying or curing step has been completed. Such an article may be attached to all kinds of documents or other articles or items without printing or other processes involving machinery and rather high effort. Alternatively, the substrate described herein comprising the machine readable security feature described herein may be in the form of a transfer foil, which can be applied to a document or to an article in a separate transfer step. For this purpose, the substrate is provided with a release coating, on which the machine readable security feature are produced as described herein. One or more adhesive layers may be applied over the so produced the machine readable security feature.

Also described herein are substrates, security documents, decorative elements and objects comprising more than one, i.e. two, three, four, etc. machine readable security feature described herein. Also described herein are articles, in particular security documents, decorative elements or objects, comprising the machine readable security feature described herein.

As mentioned hereabove, the machine readable security features described herein may be used for protecting and authenticating a security document or decorative elements.

Typical examples of decorative elements or objects include without limitation luxury goods, cosmetic packaging, automotive parts, electronic/electrical appliances, furniture and fingernail articles.

Security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets, academic diploma or titles and the like, preferably banknotes, identity documents, right-conferring documents, driving licenses and credit cards. The term “value commercial good” refers to packaging materials, in particular for cosmetic articles, nutraceutical articles, pharmaceutical articles, alcohols, tobacco articles, beverages or foodstuffs, electrical/electronic articles, fabrics or jewelry, i.e. articles that shall be protected against counterfeiting and/or illegal reproduction in order to warrant the content of the packaging like for instance genuine drugs. Examples of these packaging materials include without limitation labels, such as authentication brand labels, tamper evidence labels and seals. It is pointed out that the disclosed substrates, value documents and value commercial goods are given exclusively for exemplifying purposes, without restricting the scope of the invention.

The machine readable security features comprising the one or more IR absorbing materials described herein may consist of a pattern, an image, an indicium, a logo, a text, a number, or a code (like a bar code or a QR-code).

The present invention further provides methods for authenticating a security document comprising the steps of a) providing the security document described herein and comprising the machine readable security feature made of the security ink recited described herein; b) illuminating the machine readable security feature at at least one wavelength in the IR range (preferably between 780 nm and 3000 nm, more preferably between 780 nm and 1600 nm and still more preferably between 800 nm and 1000 nm), c) detecting the optical characteristics of the machine readable security feature through sensing of light reflected by and/or transmitted through said machine readable security feature at at least one wavelength, wherein said at least one wavelengths is in the in the IR range (preferably between 780 nm and 3000 nm, more preferably between 780 nm and 1600 nm and still more preferably between 800 nm and 1000 nm); and d) determining the security document authenticity from the detected optical characteristics of the machine readable security feature. The present inventions also provides methods for authenticating a security document comprising the steps of a) providing the security document described herein and comprising the machine readable security feature made of the security ink recited described herein; b) illuminating the machine readable security feature at at least two wavelengths, wherein one of said at least two wavelengths is in the visible range (400-700 nm) and another one of said at least two wavelengths is in the IR range (preferably between 780 nm and 3000 nm, more preferably between 780 nm and 1600 nm and still more preferably between 800 and 1000 nm), c) detecting the optical characteristics of the machine readable security feature through sensing of light reflected by and/or transmitted through said machine readable security feature at at least two wavelengths, wherein one of said at least two wavelengths is in the visible range and another one of said at least two wavelengths is in the IR range (preferably between 780 nm and 3000 nm, more preferably between 780 nm and 1600 nm and still more preferably between 800 nm and 1000 nm); and d) determining the security document authenticity from the detected optical characteristics of the machine readable security feature.

The authentication of the machine readable security features described herein and made of the security inks described herein may be performed by using an authenticating device comprising one or more light sources, one or more detectors, an analog-to-digital converter and a processor. The machine readable security feature is, simultaneously or subsequently, illuminated by the one or more light sources; the one or more detectors detect the light reflected by or transmitted through said machine readable security feature and output an electrical signal proportional to the light intensity; and the analog-to-digital converter converts said signals into a digital information that is compared by the processor to a reference stored in a database. The authenticating device then outputs a positive signal of authenticity (i.e. the machine readable security feature is genuine) or a negative signal (i.e. the machine readable security feature is fake).

According to one embodiment, the authenticating device comprises a first source (such as a VIS LED) emitting at a first wavelength in the visible range, a second source (such as an IR LED) emitting at a second wavelength in the IR range and a broadband detector (such as a photomultiplier). The first and second sources emit at a time interval, allowing the broadband detector to separately output signals corresponding to the VIS and IR emissions, respectively. These two signals may be compared separately (the VIS signal with the VIS reference and the IR signal with the IR reference). Alternatively, these two signals may be converted to a difference (or ratio) value and said difference (or ratio) value may be compared to the difference (or ratio) reference stored in the database. The signals may be read in reflection and/or in transmission.

According to another embodiment of the detector unit, and with the aim of increasing the operational speed, said detector may comprise two detectors specifically matched to the emission wavelength of the first and second sources (such as a Si photodiode for the visible range and an InGaAs photodiode for the IR range). The first and second sources emit at the same time, the two detectors sense the light reflected by or transmitted through the security feature at the same time, and the two signals (or their difference or ratio) are compared to references stored in the database.

According to another embodiment, and with the aim of increasing the resistance against counterfeiting, the authenticating device comprises a source emitting at a plurality (i.e. two, three, etc.) of wavelengths in the VIS range and at a plurality (i.e. two, three, etc.) of wavelengths in the IR range. The sources are sequentially activated, and the light reflected by or transmitted through the machine readable security feature is detected by a broadband detector (such as a photomultiplier). The signals corresponding to the plurality of emission wavelengths are then processed into a complete spectrum, which is compared to a reference spectrum stored in a database.

According to another embodiment, and with the aim of increasing the resistance against counterfeiting as well as increasing the operational speed, the authenticating device comprises a broadband, continuous light source (such as a tungsten, tungsten halogen or a xenon lamp), a collimation unit, a diffraction grating and a detector array. The diffraction grating is placed in the optical path after the machine readable security feature, wherein the light reflected by or transmitted through said machine readable security feature is focused to the grating by the collimation unit (usually made of a series of lenses and/or an adjustable slit). The detector array is made of a plurality of detector elements, each of them being sensitive to a specific wavelength. In this way, signals corresponding to the light intensity at a plurality of wavelengths are simultaneously obtained, are processed as a complete spectrum and are compared to a reference spectrum in a database.

In another embodiment, and with the aim of acquiring a two-dimensional image of the machine readable security feature described herein, the detector may be a CCD or CMOS sensor. In this case, the range of detectable wavelengths is from about 400 nm to about 1100 nm (which is the upper detection limit of silicium sensors). The machine readable security feature is illuminated sequentially at at least two wavelengths, wherein one of said at least two wavelengths is in the visible range and the other one is in the IR range accessible to the CCD or CMOS detector. Alternatively, the CCD or CMOS sensor may be equipped with a filter layer, such that individual pixels of the sensor are sensitive to a different and limited region of the visible and IR spectrum. In this case, it is possible to simultaneously obtain two-dimensional images of the machine readable security feature at at least two wavelengths, one in the visible range and the other one in the IR range accessible to the CCD or CMOS detector. The two-dimensional images are then compared to reference images stored in a database.

Optionally, the authenticating device may comprise one or more light diffusing elements (like a condenser), one or more lens assemblies (like focusing or collimating lenses), one or more slits (adjustable or not), one or more reflecting elements (like mirrors, especially semi-transparent mirrors) one or more filters (such as polarizing filters) and one or more fiber optics elements.

The skilled person can envisage several modifications to the specific embodiments described above without departing from the spirit of the present invention. Such modifications are encompassed within the present invention.

Further, all documents referred to throughout this specification are hereby incorporated by reference in their entirety as set forth in full herein.

### EXAMPLES

The present invention is now described in more details with reference to non-limiting examples. The Examples below provide more detail for the preparation and use of security inks for printing a machine readable security feature, said security inks independently comprising the IR absorbing material consisting of copper hydroxide phosphate Cu₂PO₄(OH) (CAS-Nr. 12158-74-6) having the libethenite crystal structure, a particle size d50 of 2.0-2.6 μm and a particle size d98 of 7.5-12.0 μm. Laser diffractometry was used to determine the d50 and d98 values (instrument: (Cilas 1090); sample preparation: the IR absorbing material was added to distilled water, until the laser obscuration reached the operating level of 13-15%, and the measurement was performed according to the ISO norm 13320.

Four types of security inks have been prepared and applied on a substrate:
a) water-based thermal drying flexography printing security ink (Example E1),
b) solvent-based thermal drying rotogravure printing security ink (Example E2),
c) solvent-based thermal drying screen printing security ink (Example E3), and
d) UV-Vis curable screen printing security ink (Example E4).

I. Security Inks Preparation and Security Features Preparation

A. Water-Based Thermal Drying Flexography Printing Security Ink (Example E1)

A.1. Preparation of the Water-Based Thermal Drying Flexography Printing Security Ink (E1)

The ink vehicle described in Table 1A was prepared by adding 429 g of the described acrylic resin to a solution comprising 239 g of water, 214 g of ethanol and 26 g of ammonia and stirring until full dissolution of the resin. Subsequently, 21 g of the antifoaming agent, 57 g of the wetting agent and 14 g of the dispersing agent were added. The so-obtained mixture was dispersed at room temperature using a Dispermat (FT) during ten minutes at 1500 rpm.

300 g of the IR absorbing compound copper hydroxide phosphate were added to 700 g of the ink vehicle described in Table 1A and dispersed for ten minutes at 1500 rpm. The mixture was then dispersed during five minutes at 2000 rpm so as to obtain one kg of the thermal drying flexographic printing security ink E1 (Table 1B).

The viscosity value provided in Table 1B was measured on about 15 g of the security ink at 25° C. on a Brookfield viscometer (model “RVDV-I Prime”, spindle 21 at 100 rpm).

TABLE 1A

| | Commercial | | wt- |
|---|---|---|---|
| Ingredients | name/supplier | Chemical composition (CAS) | % |
| Resin | Neocryl ® BT- | Acrylic copolymer | 42.9 |
| | 100/DSM | 40 wt-% active ingredient | |
| | Neoresins | (CAS not available) | |
| | | 60 wt-% water (7732-18-5) | |
| Solvent 1 | Demineralized | (7732-18-5) | 23.9 |
| | water | | |
| Solvent 2 | Ethanol/ | 90 wt-% Ethanol (64-17-5), | 21.4 |
| | Brenntag | 5 wt-% Water (7732-18-5), and | |
| | | 5 wt-% Isopropanol (67-63-0) | |
| Base | Ammonia 25%/ | 25 wt-% Ammonium hydroxide | 2.6 |
| | Breentag | (1336-21-6) | |
| | | 75 wt-% Water (7732-18-5) | |
| Anti-foam | Tego ® Airex | (CAS not available) | 2.1 |
| agent | 901W/Evonik | | |
| Wetting | Disperbyk ®- | 40 wt-% Active ingredient | 5.7 |
| agent | 190/BYK | (CAS not available) | |
| | | 60 wt-% Water (77732-18-5) | |
| Dispersing | Solsperse ™ | (CAS not available) | 1.4 |
| agent | 27000/Lubrizol | | |

TABLE 1B

| Security | ink vehicle as described | IR-absorbing | Viscosity at 25° C. |
|---|---|---|---|
| ink | in Table 1A | compound | and 100 rpm |
| E1 | 70 wt-% | 30 wt-% | 251 mPa s |

A.2. Preparation of the Printed Machine Readable Security Feature with the Thermal Drying Flexographic Printing Security Ink E1

The security ink E1 was printed at a speed of 30 m/min on a PET substrate (corona treated, 19 μm thickness) so as to form a machine readable security feature in the form of a dried coating having a thickness of 3-5 μm by a laboratory pilot flexography printing unit (Flexo Norbert Schlath Engler Maschinen) with an anilox roller (55 l/m, 20 cm³/m²). After printing, the security feature was dried online with hot air at 90° C.

B. Solvent-Based Thermal Drying Rotogravure Printing Security Ink (Example E2)

B.1. Preparation of the Solvent-Based Thermal Drying Rotogravure Printing Security Ink (E2)

The ingredients of the ink vehicle described in Table 2A were mixed and dispersed at room temperature using a Dispermat (FT) during 30 minutes at 2500 rpm.

300 g of the IR absorbing compound copper hydroxide phosphate were added to 700 g of the ink vehicle described in Table 2A and dispersed for ten minutes at 1500 rpm so as to obtain one kg of the thermal drying rotogravure printing security ink E2 described in Table 2B.

The viscosity value provided in Table 2B was measured on 15 g of the security ink at 25° C. on a Brookfield viscometer (model “RVDV-I Prime”, spindle 21 at 100 rpm).

TABLE 2A

| | Commercial | | wt- |
|---|---|---|---|
| Ingredients | name/supplier | Chemical composition (CAS) | % |
| Resin | Acronal ® 4F/ | N-butyl acrylate | 7.2 |
| | BASF | homopolymer (9003-49-0) | |
| Resin | Vinnol ® E22/48A/ | Copolymer of vinyl chloride | 12.1 |
| | Wacker | and carbon acid esters | |
| | | (114653-42-8) | |
| Solvent 1 | Ethylacetate/ | (141-78-6) | 50 |
| | Brenntag | | |
| Solvent 2 | N-propylacetate/ | (109-60-4) | 30.7 |
| | Thommen-Furler | | |

TABLE 2B

| Security | ink vehicle as described | IR-absorbing | Viscosity at 25° C. |
|---|---|---|---|
| ink | in Table 2A | compound | and 100 rpm |
| E2 | 70 wt-% | 30 wt-% | 114 mPa s |

B.2. Preparation of the Printed Machine Readable Security Feature with the Solvent-Based Thermal Drying Rotogravure Printing Security Ink E2

The security ink E2 was printed was printed at a speed of 30 m/min on a PET substrate (corona treated, 19 μm thickness) so as to form a machine readable security feature in the form of a dried coating having a thickness of 3-5 μm by a laboratory pilot rotogravure printing unit (Gravure Norbert Schläfli Engler Maschinen) with a cylinder having a gravure of 54 l/cm and a cell depth of 60 μm. After printing, the security feature was dried online with hot air at 90° C.

C. Solvent-Based Thermal Drying Screen Printing Security Ink (Example E3)

C.1. Preparation of the Solvent-Based Thermal Drying Screen Printing Security Ink (E3)

The ingredients of the ink vehicle described in Table 3A were mixed and dispersed at room temperature using a Dispermat (FT) during 15 minutes at 1000 rpm.

120 g of the IR absorbing compound copper hydroxide phosphate were added to 880 g of the ink vehicle described in Table 3A and dispersed for ten minutes at 1200 rpm so as to obtain one kg of the thermal drying screen printing security ink E3 described in Table 3B.

The viscosity value provided in Table 3B was measured on about 15 g of the security ink vehicle at 25° C. on a Brookfield viscometer (model “RVDV-I Prime”, spindle 27 at 100 rpm).

TABLE 3A

| | Commercial | | wt- |
|---|---|---|---|
| Ingredients | name/supplier | Chemical composition (CAS) | % |
| Resin | Neocryl ® B-728/ | Acrylic homopolymer, | 20.0 |
| | DSM Neoresins | MW ~65000 g/mol (CAS not | |
| | | available) | |
| Solvent 1 | Butylglycol acetate/ | 2-Butoxyethyl acetate | 51.5 |
| | (Brenntag- | (112-07-2) | |
| | Schweizer) | | |
| Solvent 2 | Ethyl 3- | Ethyl 3-ethoxypropionate | 16.9 |
| | ethoxypropionate/ | (763-69-9) | |
| | Brenntag- | | |
| | Schweizer) | | |
| Solvent 3 | Dowanol ™ DPM/ | (2-Methoxymethylethoxy) | 7.5 |
| | Dow Chemicals | propanol (34590-94-8) | |
| Anti- | BYK ®-1752/ | Silicone-free defoamer (CAS | 3.7 |
| foaming | BYK | not available) | |
| agent | | | |
| Filler | Aerosil ® 200/ | Silicon dioxide (7631-86-9) | 0.4 |
| | Evonik | | |

TABLE 3B

| Security | ink vehicle as described | IR-absorbing | Viscosity at 25° C. |
|---|---|---|---|
| ink | in Table 3A | compound | and 100 rpm |
| E3 | 88 wt-% | 12 wt-% | 1350 mPa s |

C.2. Preparation of the Printed Machine Readable Security Feature with the Thermal Drying Screen Printing Security Ink E3

The security ink E3 was applied by hand on a piece of fiduciary paper (BNP paper from Louisenthal, 100 g/m², 14.5 cm×17.5 cm) using a 90 thread/cm screen (230 mesh), so as to form a machine readable security feature in the form of a dried coating having a thickness of 5-8 μm. The printed pattern had a size of 6 cm×10 cm. After printing, the security feature was dried with a hot air drier at a temperature of about 50° C. for about one minute.

D. UV Curable Screen Printing Security Ink (Example E4)

D.1. Preparation of the UV Curable Screen Printing Security Ink (E4)

The ingredients of the ink vehicle described in Table 4A were mixed and dispersed at room temperature using a Dispermat (FT) during 15 minutes at 1000-1500 rpm.

120 g of the IR absorbing compound copper hydroxide phosphate were added to 880 g of the ink vehicle described in Table 4A and dispersed for ten minutes at 1200 rpm so as to obtain one kg of the UV curable screen printing security ink E4 described in Table 4B.

The viscosity value provided in Table 4B was measured on about 15 g of the security vehicle at 25° C. on a Brookfield viscometer (model “RVDV-I Prime”, spindle 27 at 100 rpm).

TABLE 4A

| | Commercial | | wt- |
|---|---|---|---|
| Ingredients | name/supplier | Chemical composition (CAS) | % |
| Oligomer | Ebecryl ® | Acrylated epoxy resin | 33.4 |
| | 2959/Allnex | 23 wt-% glycerol propoxylated | |
| | | triacrylate (52408-84-1) | |
| | | 77 wt-% bisphenol A epoxy | |
| | | diacrylate (55818-57-0) | |
| Monomer | TMPTA/ | Trimethylolpropane triacrylate | 23.4 |
| | Allnex | (15625-89-5) | |
| Monomer | TPGDA/ | Tripropyleneglycol diacrylate | 24.0 |
| | Allnex | (42978-66-5) | |
| Polymer- | GENORAD* | 12.1 wt-% Active ingredient | 1.2 |
| ization | 16/Rahn | (CAS not available) | |
| inhibitor | | 2.9 wt-% 4-Methoxyphenol | |
| | | (150-76-5) | |
| | | 37.5 wt-% Glycerol propoxylate | |
| | | triacrylate (52408-84-1) | |
| | | 7.5 wt-% 2,6-Di-tert-butyl-p- | |
| | | cresol (128-37-0) | |
| | | 2.5 wt-% N-nitroso-n- | |
| | | phenylhydroxylamine aluminum | |
| | | salt (15305-07-4) | |
| Photo- | Speedcure | Ethyl (2,4,6-trimethylbenzoyl) | 2.4 |
| initiator | TPO-L/ | phenyl phosphinate (84434-11-7) | |
| | Lambson | | |
| Photo- | Omnirad ® | 50 wt-% Benzophenone (119-61-9) | 7.2 |
| initiator | 500/IGM | 50 wt-% 1Hhydroxycyclohexyl | |
| | resins | phenyl ketone (947-19-3) | |
| Amine | GENOCURE* | Ethyl-4-dimethylaminobenzoate | 2.4 |
| synergist | EPD/Rahn | (10287-53-3) | |
| Filler | Aerosil ® | Silicon dioxide (7631-86-9) | 1.2 |
| | 200/Evonik | | |
| Dispersant | BYK ®-371/ | Polyester modified acrylic | 2.4 |
| | Byk | functional poly-dimethyl-siloxane | |
| | | 40.8 wt-% Active ingredient | |
| | | (CAS not available) | |
| | | 42 wt-% Xylene (1330-20-7) | |
| | | 17 wt-% Ethylbenzene (100-41-4) | |
| | | 0.2 wt-% Toluene (108-88-3) | |
| Anti- | TEGO ® | Di-methyl polysiloxanes | 2.4 |
| foaming | Foamex N/ | containing fumed silica (active | |
| agent | EVONIK | ingredient not provided by the | |
| | | supplier) | |

TABLE 4B

| Security | ink vehicle as described | IR-absorbing | Viscosity at 25° C. |
|---|---|---|---|
| ink | in Table 4A | compound | and 100 rpm |
| E4 | 88 wt-% | 12 wt-% | 770 mPa s |

D.2. Preparation of the Printed Machine Readable Security Feature with the UV Curable Screen Printing Security Ink E4

The security ink E4 was applied by hand on a piece of fiduciary paper (BNP paper from Louisenthal, 100 g/m², 14.5 cm×17.5 cm) using a 90 thread/cm screen (230 mesh), so as to form a machine readable security feature in the form of a cured coating having a thickness of about 20 μm. The printed pattern had a size of 6 cm×10 cm. After the printing step, the security feature was cured by exposing said features two times at a speed of 100 m/min to UV-Vis light under a curing unit from IST Metz GmbH (two lamps: iron-doped mercury lamp 200 W/cm²+mercury lamp 200 W/cm²).

II. Results: Optical Properties of Printed Machine Readable Security Features

The influence of the IR-absorbing material present in the security inks E1-E4 according to the invention on the visible color of the printed machine readable security features was assessed according to their L*, C* and h values, L* indicating the lightness of the printed sample, C* their chroma (or color saturation) and h their hue angle.

L*, C* and h values were independently derived from the measurement of the L*a*b* values of the printed machine readable security features according to CIELAB (1976), a* and b* being the color coordinates in a Cartesian 2-dimensional space (a*=color value along the red/green axis and b*=color value along the blue/yellow axis). The L*a*b* values were independently measured with a spectrophotometer DC 451R from Datacolor (measurement geometry: 45/0°; spectral analyzer: proprietary dual channel holographic grating. 256-photodiode linear arrays used for both reference and sample channels; light source: total bandwidth LED illumination). The substrates had a higher IR reflectance than the security feature in order not to affect the measured values. From each data point, the C* and h value were calculated according to the following equations:

$${C}^{*} = \sqrt{{( {a}^{*} )}^{2} + {( {b}^{*} )}^{2}}$$

$${h}^{*} ( rad ) = arc tan ( \frac{{b}^{*}}{{a}^{*}} ) + n π$$

wherein, the value of n depends on which quadrant of the color sphere the coordinate (a*, b*) is positioned. For example, if a* is positive and b* is negative (4^{th} quadrant), the hue h in radians will be between 0 and −π/2 (n=0), whereas if a* is negative and b* is positive (2^{nd} quadrant), it will be between π/2 and π (n=1). By definition, h values are given in degrees (°) and are always positive (in the example above, it means that, when a* is positive and b* is negative, the indicated h values will be between 270° and 360°). The L*C*h values provided in Table 5 consist average values calculated from the L*a*b* measurement of three individual spots of each printed machine readable security feature.

TABLE 5

| | E1 | E2 | E3 | E4 |
|---|---|---|---|---|
| L* | 93.4 | 93.2 | 94.0 | 93.2 |
| C* | 6.7 | 6.8 | 6.8 | 9.3 |
| h | 104 | 107 | 110 | 111 |
| Color | Light green | Light green | Light green | Light green |

The reflectance spectrum of the respective printed machine readable security features made with the security inks E1-E4 was independently measured with a DC45 from Datacolor between 400 nm and 1100 nm. The 100% reflectance was measured using the internal standard of the device. Reflectance values (in %) at selected wavelengths are provided in Table 6A and the reflectance curves are provided in the sole FIGURE.

TABLE 6A

| Reflectance [%] at | E1 | E2 | E3 | E4 |
|---|---|---|---|---|
| 400 nm | 68.4 | 68.6 | 70.8 | 46.6 |
| 500 nm | 82.1 | 81.6 | 83.8 | 81.9 |
| 600 nm | 85.8 | 85.3 | 86.5 | 85.2 |
| 700 nm | 77.0 | 69.8 | 71.8 | 69.6 |
| 800 nm | 62.7 | 47.9 | 51.7 | 49.5 |
| 900 nm | 51.5 | 33.7 | 39.1 | 37.4 |
| 1000 nm | 47.5 | 29.9 | 35.8 | 34.3 |
| 1100 nm | 44.5 | 26.3 | 34.1 | 32.6 |

TABLE 6B

| Reflectance | E1 | E2 | E3 | E4 |
|---|---|---|---|---|
| Vis | Max | Max | Max | Max |
| | reflectance: | reflectance: | reflectance: | reflectance: |
| | 86.2% at | 85.8% at | 87.3% at | 85.9% at |
| | 590 nm | 590 nm | 580 nm | 580 nm |
| IR | Min | Min | Min | Min |
| | reflectance: | reflectance: | reflectance: | reflectance: |
| | 44.2% at | 26.2% at | 33.2% at | 32.0% at |
| | 1090 nm | 1090 nm | 1080 nm | 1090 nm |

As shown in Tables 6A-B, the machine readable printed security features made from the security ink E1-E4 exhibited a significant difference between the maximum reflectance in the Vis range and the minimum reflectance (i.e. maximum absorption) in the IR, in particular the NIR, range. The exhibited reflectance values and profile render high speed detection of said security feature (i.e. machine readable characteristics) suitable by standard detectors such as those featuring high-speed banknote sorting machines, since such detectors rely on the reflectance difference at selected wavelengths in the Vis and the IR ranges of interest. The L*a*b* values of the machine readable printed security feature made from the security ink E1-E4 according to the invention corresponded to a light green color. Accordingly, machine readable printed security features made from the security ink E1-E4 according to the invention exhibited a clear and light color in the Vis range in combination with a sufficiently strong absorption in the IR, in particular NIR, range.

1. A security ink for printing a machine readable security feature, said security ink comprising one or more IR absorbing materials, said IR absorbing materials comprising one or more transition elements selected from the group consisting of Ti, V, Cr, Mn, Fe, Co, Ni, and Cu and one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates, silicates (SiO₄⁴⁻), condensed polysilicates; titanates (TiO₃²⁻), condensed polytitanates, vanadates (VO₄³⁻), condensed polyvanadates, molybdates (MoO₄²⁻), condensed molybdates, tungstates (WO₄²⁻), condensed polytungstates, niobates (NbO₃²⁻), fluorides (F⁻), chlorides (Cl⁻), sulfates (SO₄²⁻), hydroxides (OH⁻),
wherein the security ink has a viscosity between about 10 mPa s and about 3000 mPa s at 25° C.; and
wherein said security ink allows the production of a machine readable security feature having the following optical properties: a lightness L* equal to or higher than about 80, a chroma C* smaller than or equal to about 15 and a reflectance at 900 nm smaller than or equal to about 60%.

2. The security ink according to claim 1, wherein the one or more IR absorbing materials comprise Cu and one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates and hydroxides (OH⁻).

3. The security ink according to claim 1, wherein the one or more IR absorbing materials are Cu₂PO₄(OH).

4. The security ink according to claim 1 which is selected from the group consisting of screen printing inks, and inkjet printing inks.

5. The security ink to claim 1 which is a UV-curable ink comprising one or more photoinitiators.

6. The security ink according to claim 1 which is a thermal drying ink comprising one or more solvents selected from the group consisting of organic solvents, water and mixtures thereof.

7. The security ink according to claim 1, further comprising one or more iridescent pigments and/or one or more cholesteric liquid crystal pigments.

8. The security ink according to claim 1, further comprising one or more further IR absorbing compounds selected from the group consisting of doped tin oxides, doped indium oxides, reduced tungsten oxides, tungsten bronzes and mixtures thereof.

9. A machine readable security feature made from the security ink recited in claim 1 and having the following optical properties: a lightness L* equal to or higher than about 80, a chroma C* smaller than or equal to about 15 and a reflectance at 900 nm smaller than or equal to about 60%.

10. A security document comprising the machine readable security feature recited in claim 9.

11. A method for producing a machine readable security feature having the following optical properties: a lightness L* equal to or higher than about 80, a chroma C* smaller than or equal to about 15 and a reflectance at 900 nm smaller than or equal to about 60% and comprising
a step a) of applying the security ink recited in claim 1 onto a substrate.

12. The method according to claim 11, further comprising a step b) of drying and/or curing the security ink in the presence of UV-Vis radiation and/or air or heat so as to form the machine readable security feature on the substrate, said step of drying and/or curing being performed after the step a).

13. The method according to claim 11, wherein the substrate is selected from the group consisting of papers or other fibrous materials, paper-containing materials, glasses, metals, ceramics, plastics and polymers, metalized plastics or polymers, composite materials and mixtures or combinations thereof.

14. A method for authenticating a security document comprising the steps of:
a) providing the security document recited in claim 10;
b) illuminating the machine readable security feature at at least one wavelength in the IR range,
c) detecting the optical characteristics of the machine readable security feature through sensing of light reflected by or transmitted through said machine readable security feature at at least one wavelength, wherein one of said at least one wavelengths is the IR range, and
d) determining the security document authenticity from the detected optical characteristics of the machine readable security feature.

15. The method according to claim 14, wherein
step b) consists of illuminating the machine readable security feature at at least two wavelengths, wherein one of said at least two wavelengths is in the visible range and another one of said at least two wavelengths is in the IR range; and
step c) consists detecting the optical characteristics of the machine readable security feature through sensing of light reflected by or transmitted through said machine readable security feature at at least two wavelengths, wherein one of said at least two wavelengths is in the visible range and another one of said at least two wavelengths is in the IR range.

16. The security ink according to claim 1, wherein the one or more IR absorbing materials are Cu₂PO₄(OH) with a libethenite crystal structure.

17. The security ink according to claim 2, wherein the one or more IR absorbing materials comprise Cu and one or more anions selected from the group consisting of phosphates (PO₄³⁻) and hydroxides (OH⁻).

18. The security ink according to claim 4, which is selected from the group consisting of screen printing inks having a viscosity between about 50 and about 3000 mPa s at 25° C., flexography printing inks having a viscosity between about 50 and about 500 mPa s at 25° C., rotogravure printing inks having a viscosity between about 50 and about 1000 mPa s at 25° C., and inkjet printing inks having a viscosity between about 10 and about 50 mPa s at 25° C.

19. The security ink to claim 5, wherein the one or more photoinitiators is present in an amount from about 0.1 wt-% to about 20 wt-%, the weight percents being based on the total weight of the security ink.

20. The security ink according to claim 6, wherein the one or more solvents is present in an amount from about 10 wt-% to about 90 wt-%, the weight percents being based on the total weight of the security ink.
